(19) United States
(12) Patent Application Publication
(10) Pub. No.: US 2004/0148637 A1
(43) Pub. Date: Jul. 29, 2004

(54) Method and system for literal data access

(76) Inventors: Asher Sterkin, Jerusalem (IL); Menachem Vinokurov, Jerusalem (IL); Mark Goldshmidt, Jerusalem (IL); Ezra Darshan, Nofei Aviv Beit Shemesh (IL)

Correspondence Address: Ladas & Parry, 26 West 61st Street, New York, NY, 10023, US

(21) Appl. No.: 10/469,487

(22) PCT Filed: Mar. 10, 2002
(86) PCT No.: PCT/IL02/00190

(51) Int. Cl. H04N 7/173; G06F 13/00; H04N 5/445; G06F 17/00; G06F 7/00; G06F 3/00; G06F 17/30

(52) U.S. Cl. 725/115; 725/53; 725/117; 725/86; 725/61; 707/1; 707/3; 707/100

(57) ABSTRACT

A method for accessing at least one literal data item in a hierarchical structure, the method including receiving a request to access at least one literal data item, and accessing the at least one literal data item, at least in part, by choosing and using an access method chosen from the following group: local storage access, back channel access, and data carousel access. Related methods and apparatus are also disclosed.

### RELATED APPLICATIONS

The present invention is related to U.S. Provisional Patent Application No. 60/276,694, entitled Data Representation System, filed Mar. 16, 2001, assigned to the same assignee as the present application, the contents of which are incorporated herein by reference in their entirety.

### FIELD OF THE INVENTION

The present invention relates generally to a method and system for literal data access, such as but not limited to, literal data items in a hierarchical structure.

### BACKGROUND OF THE INVENTION

As is well known, the Internet is an international network based on various standard protocols and transfer mechanisms. The Internet provides an interactive image and document presentation system which enables users to selectively access desired information and/or graphics content. The Internet preferably includes various server types, including World Wide Web (WWW or “web”) servers that offer hypertext capabilities. Hypertext capabilities preferably allow the Internet to link together a web of documents, which can be navigated using a convenient graphical user interface (GUI). WWW servers preferably use Uniform Resource Locators (URLs) to identify documents, wherein the URL is the address of the document that is to be retrieved from a network server. The WWW preferably uses a hypertext language referred to as the hypertext mark-up language (HTML), which is a scripting or programming language that allows content providers or developers to place hyperlinks within web pages which link related content or data. The web also preferably uses a transfer protocol referred to as HyperText Transfer Protocol (HTTP). When a user clicks on a link in a web document, the link in the document contains the URL used to initiate the session with the server storing the linked document. HTTP is the protocol used to support the information transfer.

As with many languages, HTML is constantly being extended and modified. The World Wide Web Consortium (W3C) oversees new extensions of HTML developed by both software companies and individual web page authors and ensures that each new specification is fully compatible with previous ones. Basic features supported by HTML include headings, lists, paragraphs, tables, electronic forms, in-line images (images next to text), and hypertext links. Some examples of enhancements to the original HTML specification include banners, the applet tag to support Java, image maps, and text flow around images.

One well known extension of HTML is Dynamic HTML (DHTML). DHTML allows web pages to function more like interactive CD-ROMs by responding to user-generated events. DHTML allows web page objects to be manipulated after they have been loaded into a browser. This enables users, for example, to avoid bandwidth-consuming return trips to the server. For example, headers may move across the page based on a user's mouse movements.

An attempt to standardize extensions of HTML includes a specification called the Document Object Model (DOM). The W3C handles the development of the DOM, and information related thereto is accessible at the URL www.w3c.org/dom. As stated in the objectives of the W3C (found at that URL), “W3C's DOM is a standard API (Application Programming Interface) to the structure of documents; it aims to make it easy for programmers to access components and to delete, add, or edit their content, attributes and style. In essence, the DOM makes it possible for programmers to write applications which work properly on all browsers and servers and on all platforms. While programmers may need to use different programming languages, they do not need to change their programming model.” The DOM is a platform-neutral and language-neutral interface that preferably enables programs and scripts to dynamically access and update the content, structure and style of documents. The document may be further processed and the results of that processing may be incorporated back into the presented page.

The DOM categorizes web page elements (e.g., text, images, and links) as objects, and specifies the attributes that are associated with each object. The DOM preferably makes web document objects accessible to scripting languages, such as JavaScript and ECMAScript, which may be used to change the appearance, location, and content of the objects in real-time. The DOM may define document objects associated with the document's content and attributes, including relationships, associated versions, renditions, formats, workflow characteristics, and security. These document objects may be combined and re-combined at will to form dynamic configurations of document objects that may come from any source.

HTML and Dynamic HTML preferably provide control over the ways in which a web page is displayed. Another language, called Extensible Markup Language (XML), is designed to provide access and management of data in web documents so as to gain more control over document structure. XML is a meta-language that preferably allows authors to create their own customized tags to identify different types of data on their web pages. In addition to improving document structure, the tags may enable better indexing and search of information in databases and the web.

XML documents preferably consist of two parts. The first is the document itself, which contains XML tags for identifying data elements and resembles an HTML document. The second part defines the document structure by explaining what the tags mean and how they should be interpreted. In order to view XML documents, web browsers and search engines preferably need special XML processors called “parsers.”

Generic APIs for XML and other languages may be generally classified in two categories: event-based or tree-based.

A tree-based API typically compiles an XML document into an internal tree structure, then allows an application to navigate that tree. The DOM is a generic tree-based API for XML and HTML documents.

An event-based API, on the other hand, typically reports parsing events (such as the start and end of elements) directly to the application through callbacks, and does not generally build an internal tree.

Tree-based APIs typically have a wide range of applications, but may task system resources, especially if the document is large. In contrast, an event-based API may provide a simpler, lower-level access to the document. In the event-based API, it may be possible to parse documents significantly larger than the available system memory.

The foregoing has been a general explanation of some features of the Internet. However, the Internet is just one kind of interactive communications system. Another kind is interactive television, which is now briefly discussed.

Interactive television is an interactive audio/video delivery medium which provides broadcast audiovisual content to a plurality of users, and also provides a return path for the users to interact with the content, e.g., to make selections or order desired products, and the like. One element of interactive television is the ability to provide electronic program guides and/or electronic catalogs, which allow viewers to order programming or merchandise. An advertiser may advertise his product through interactive television, and the user may view and make selections to order the product or receive more information on the product.

It would be desirable to combine features of the Internet with interactive television. However, one problem in providing web-like capabilities in an interactive television system is the broadcast nature of the system. The Internet is essentially a multi-point to multi-point network wherein each user may selectively retrieve different information or view different selected content. In contrast, the broadcast television medium is primarily a point to multi-point network where every user is generally required to receive the same content. Therefore, an improved interactive television system and method is desired which provides web-like capabilities in a broadcast environment.

Several documents in the patent literature attempt to provide web-like capabilities in an interactive television system. For example, U.S. Pat. No. 6,275,989 to Broadwin, et al., describes a system and method for displaying still video images related to video content in an interactive broadcast television system. The system may be used for simulating an Internet home page on an interactive television system, and may support hyperlinked web-like navigational capabilities. The video delivery system of U.S. Pat. No. 6,275,989 may provide or broadcast one or more audio/video channels, each comprising video content, and provide or broadcast at least one still image channel comprising a plurality of still video images, preferably MPEG-2 compressed still images. The user or viewer may select options displayed on the television screen to view desired information. When a set-top box (STB) receives user input selecting an option to view one of the linked still images, the STB captures the requested image from the still image broadcast channel, stores the image in memory, and displays the captured still video image corresponding to the selection. The still image being displayed may have associated interactive program content for displaying further selections, e.g., viewing other images or content, ordering information, or purchasing products. The user may thus selectively navigate between the video content and stills in a web-like hyperlinked fashion. The STB preferably also pre-caches or pre-loads other related still images based on the probability that these related images might be subsequently requested by the user.

U.S. Pat. No. 6,317,885 to Fries describes an interactive entertainment and information system using a television STB, wherein pages of information are periodically provided to the STB for user interaction therewith. The pages include associated meta-data defining active locations on each page. When a page is displayed, the user interacts with the active locations on the page by entering commands via a remote control device, whereby the system reads the meta-data and takes the action associated with the location. Actions include moving to other active locations, hyperlinking to other pages, entering user form data and submitting the data as a form into memory. The form data may be read from memory, and the pages may be related to a conventional television program, thereby providing significant user interactivity with the television.

An information service server used in U.S. Pat. No. 6,317,885 includes a data carousel delivery application for delivering a carousel of rendered HTML page images to the STB along with meta-data for each page. Each page image preferably consists of a single frame MPEG2 video sequence that is capable of being decoded by an MPEG video decoder in the STB. The meta-data for each page describe the structure and contents of the page image.

U.S. Pat. No. 6,263,501 to Schein, et al., describes systems and methods for providing television schedule information to a viewer, and for allowing the viewer to link, search, select and interact with information in a remote database, e.g., a database on the Internet. The television schedule information can be displayed on a variety of viewer interfaces, such as television screens, computer monitors, PCTV screens and the like. The television schedule information may be stored on the viewer's computer, television, PCTV, or a remote server (e.g., a website), or the television schedule information may be downloaded from a remote database to the viewer's computer, television or PCTV. Program scheduling may be sent in a data carousel.

U.S. Pat. No. 6,177,930 to Chernock, et al. describes an interactive video presentation system that receives a plurality of series of digital data segments (e.g., image frames). Each series of digital data segments appears at the video presentation system on a repetitive, cyclic basis. Each digital data segment includes a first data portion from which an image can be constructed, a second data portion which includes information relating to the image, and further includes, if required, information which links an active area of the image to another data source. A processor is responsive to a user's selection of an active area on a displayed image to employ information from the second data portion that is associated with the displayed image to operate a switch to access another data source. The other data source can be another data segment, a video presentation, or an audio presentation. The video presentation system is operable without requiring a reverse channel for communications with a transmission head end.

U.S. Pat. No. 6,047,317 to Bisdikian, et al. describes a video presentation system, similar to U.S. Pat. No. 6,177,930. The system of U.S. Pat. No. 6,047,317 receives a plurality of series of digital data segments (e.g., image frames) that are cyclically transmitted, wherein certain of the digital data segments manifest a higher priority and are present in the form of plural, time-spaced copies during a series of the digital data segments. An STB, which serves as the receiver, may also be provided with sufficient memory to buffer a certain number of the higher priority digital data segments.

U.S. Pat. No. 5,978,855 to Metz et al. describes a system for downloading application software and transmitting audio/video information through one channel of a digital broadcast network. The network also provides two-way, low-speed data communications capacity, e.g. for signaling and/or interactive text services. Signaling via data communication with a text server controls downloading of executable code from the digital broadcast channel into a programmable digital set-top terminal. Execution of the downloaded code in turn controls selective capture and presentation of audio and video segments received over one of the digital broadcast channels. Resident operating system and application software in the terminal provides all communication with nodes of the network. The downloaded code forms a non-resident application having a set of predetermined function calls for activating communication functions of the resident software.

Published U.S. patent application Ser. No. 2001/0037507 to Mori describes a broadcasting system including a broadcasting apparatus and a receiving apparatus. The broadcasting apparatus transmits an interactive content as a data carousel during a scheduled broadcasting time period, starts pre-transmitting the interactive content a predetermined time before the start of the scheduled broadcasting time period, and repeatedly transmits a cache message instructing a receiving apparatus to cache the interactive content into a storage unit while the interactive content is transmitted during the predetermined time period. The receiving apparatus receives and reproduces the interactive content, and caches the interactive content into a storage unit.

The disclosures of all references mentioned above and throughout the present specification are hereby incorporated herein by reference.

### SUMMARY OF THE INVENTION

The present invention seeks to provide improved methods and system for literal data access.

There is thus provided in accordance with a preferred embodiment of the present invention a method for accessing at least one literal data item in a hierarchical structure, the method including receiving a request to access at least one literal data item, and accessing the at least one literal data item, at least in part, by choosing and using an access method chosen from the following group local storage access, back channel access, and data carousel access. The choosing may be done automatically.

There is also provided in accordance with a preferred embodiment of the present invention a method for accessing at least one literal data item in a hierarchical structure, the method including receiving a request to access at least one literal data item, and accessing the at least one literal data item, at least in part, by using a data carousel access.

In accordance with a preferred embodiment of the present invention the data carousel access includes at least partially cached data carousel access.

Further in accordance with a preferred embodiment of the present invention the hierarchical structure includes a standard hierarchical structure, such as but not limited to, a standard hierarchical structure described by the Document Object Model (DOM) specification.

There is also provided in accordance with a preferred embodiment of the present invention a method for accessing at least one literal data item in a hierarchical structure, the method including receiving a DOM format request to access at least one literal data item, and fulfilling the DOM format request via data carousel access.

In accordance with a preferred embodiment of the present invention a request and/or receipt of notification may be given when the at least one literal data item has been added, changed or deleted.

Further in accordance with a preferred embodiment of the present invention the hierarchical structure is operable by an application programming interface (API), such as an event-based API or a tree-based API.

Still further in accordance with a preferred embodiment of the present invention content is provided that includes the at least one literal data item, the content including a presentation component and data.

In accordance with a preferred embodiment of the present invention the presentation component is separated from the data.

Further in accordance with a preferred embodiment of the present invention the presentation component is broadcast in ASCII format.

Still further in accordance with a preferred embodiment of the present invention the data is broadcast in a binary format.

There is also provided in accordance with a preferred embodiment of the present invention a system for accessing at least one literal data item in a hierarchical structure, including a set-top box (STB) adapted to receive a request to access at least one literal data item, and to access the at least one literal data item, at least in part, by choosing and using an access method chosen from the following group local storage access, back channel access, and data carousel access.

In accordance with a preferred embodiment of the present invention the STB includes a processor adapted to automatically choose which of the local storage access, back channel access, and data carousel access to access the at least one literal data item.

Further in accordance with a preferred embodiment of the present invention a headend is provided that includes an application generator adapted to broadcast to the STB via a data carousel.

Still further in accordance with a preferred embodiment of the present invention the application generator is adapted to receive content from a content provider.

In accordance with a preferred embodiment of the present invention the application generator is adapted to separate the presentation component from the data.

Further in accordance with a preferred embodiment of the present invention the presentation component includes at least one of static HTML pages and dynamic HTML (DHTML) pages.

Still further in accordance with a preferred embodiment of the present invention the data includes XML data.

In accordance with a preferred embodiment of the present invention the STB includes an extended TV (XTV) local file system.

### BRIEF DESCRIPTION OF THE DRAWINGS

The present invention will be understood and appreciated more fully from the following detailed description taken in conjunction with the appended drawings in which:

FIG. 1 is a generalized illustration of a system for literal data access, constructed and operative in accordance with a preferred embodiment of the present invention;

FIG. 2 is a more detailed illustration of a system for literal data access, constructed and operative in accordance with a preferred embodiment of the present invention; and

FIG. 3 is a simplified flow chart of a method for literal data access, in accordance with a preferred embodiment of the present invention.

### DETAILED DESCRIPTION OF PREFERRED EMBODIMENTS

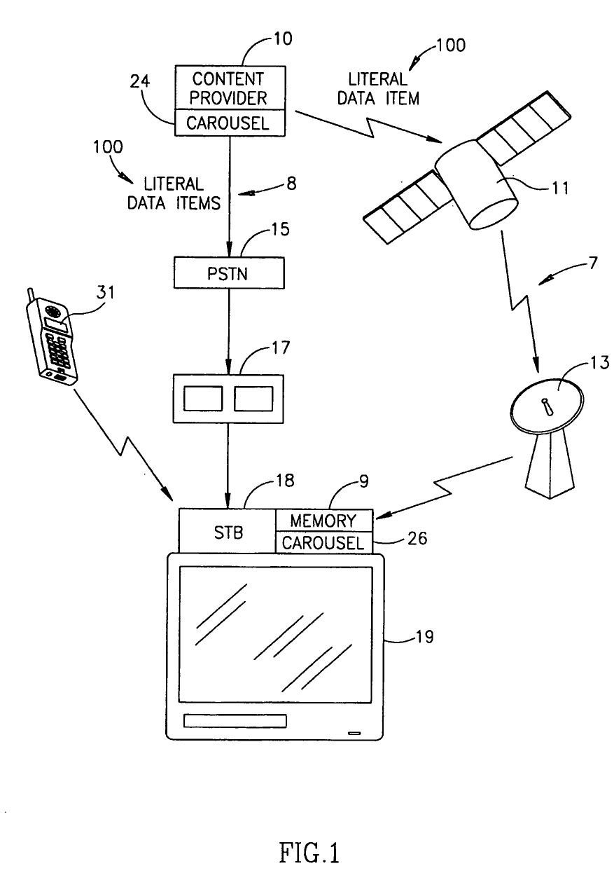

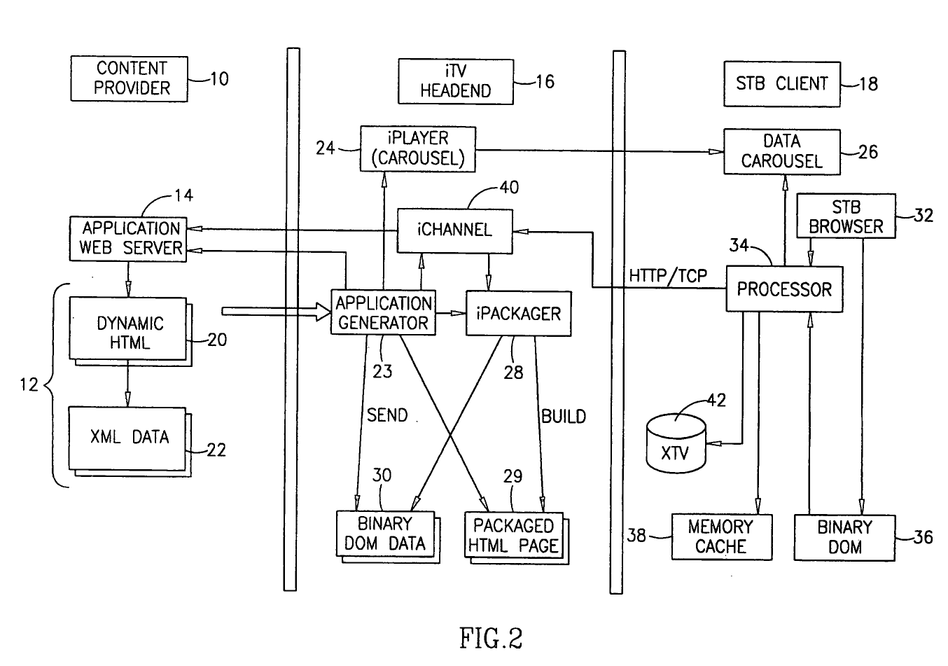

Reference is now made to FIG. 1, which is a generalized illustration of a system for literal data access, constructed and operative in accordance with a preferred embodiment of the present invention. A preferred embodiment of the system of the invention is described more in detail with reference to FIG. 2 hereinbelow.

A content provider 10 may provide electronic content and items via a front channel 7 and a back channel 8. The front channel 7 may include, for example, a broadcast via a transmitter 11 (e.g., satellite transmitter) to a receiver 13, which is in communication with a set-top box (STB) 18 of a television set 19. The front channel 7 may be of high bandwidth. The back channel 8 may include, for example, a publicly switched telephone network (PSTN) 15, which is in communication with STB 18, such as via a phone jack 17. It is appreciated that the invention is not limited to using PSTN, and may employ other types of communication paths, such as but not limited to, DVB-RC (digital video broadcasting-return channel), DOCSIS (data over cable service interface specification) or any other appropriate kind of return path. The back channel 8 may be used to send Internet content, for example. The back channel 8 may be of low bandwidth. The STB 18 preferably includes a memory 9 for local storage of information received via the front channel 7 or the back channel 8. As is explained more in detail with reference to FIG. 2, information may be broadcast via a data carousel 24. At least part of the broadcast data carousel may be stored in a cache (herein referred to as data carousel 26), which may be part of, or separate from, the STB 18, thus providing at least partially cached data carousel access.

In accordance with a preferred embodiment of the present invention, the system of the invention enables accessing one or more literal data items 100 received by the STB 18. A user interface device 31, such as but not limited to, a remote control device, may be used to issue commands for accessing literal data items 100. A user may interactively request and gain access to the one or more literal data items 100, at least in part, by local storage access (e.g., from memory 9 of STB 18), back channel access (e.g., via PSTN 15), and/or data carousel access (e.g., via data carousel 26). Preferably the system automatically chooses the type of access by which to retrieve the literal data items. Alternatively, the user may manually choose the type of access.

A “literal data item” is defined as any portion of a document or other content provided by content provider 10. For instance, the third letter of the third word in the third paragraph in the third page of a novel available from some content provider is an example of a literal data item. Another example is the prelude of a fugue downloaded from a website on the Internet. Yet another example is the video content of the last two minutes of the last Tour de France cycling competition broadcast on a subscriber television network. Literal data items 100 are preferably accessible by some application program interface (API), such as but not limited to, an event-based API or a tree-based API. For example, literal data items 100 may be accessible in a hierarchical structure, such as a standard hierarchical structure described by the Document Object Model (DOM) specification.

The system of the present invention may provide a variety of interactive TV services for providing access to the literal data items. As is described further in detail hereinbelow, the iTV system may provide bandwidth optimization and response-time minimization through intelligent use of the broadcast delivery mechanism and STB local storage. The system may further provide real-time updates, application scheduling, synchronized video and data, secure transactions and controlled data access. The iTV system may operate with different kinds of HTML-based platforms, such as but not limited to, HTML 4.0, DOMO, ECMAScript, ActiveX or JavaBeans support.

Reference is now made to FIG. 2, which is a more detailed illustration of a system for literal data access, constructed and operative in accordance with a preferred embodiment of the present invention. The content provider 10 preferably provides content 12 in the front channel via an application web server 14 to an iTV headend 16 for broadcasting to one or more STBs 18. Content 12 preferably includes a presentation component 20 and data 22. The presentation component 20 may comprise, without limitation, static HTML pages or dynamic HTML (DHTML) pages, for example. The data 22 may comprise, without limitation, XML data, for example. For example, DHTML pages preferably use data 22 received from the content provider 10 that is encoded in the application-specific XML format and which may be generated on-the-fly. Content provider 10 preferably authors data 22 only once for all the supported platforms. Content provider 10 may author the presentation component 20 independently for each platform, in order to take advantage of specific platform strengths.

The headend 16 preferably includes an application generator 23, which may be considered a proxy server that controls broadcasting the content 12 to the STBs 18. The use of the application generator 23 may reduce out-of-band network traffic and improve bandwidth utilization. In addition, use of the application generator 23 may provide faster access to the application and guaranteed access to the broadcast content.

The application generator 23 preferably employs an interactive player (iPlayer) in broadcasting the data carousel to the STBs 18. The presentation component 20 and data 22 may be processed or modified before broadcasting to the STBs 18. In accordance with a preferred embodiment of the present invention, the presentation component 20 may be separated from the data 22. For example, the application generator 23 may employ an interactive packager (iPackager) 28 that prepares a package 29 of the presentation component 20 and a processed version 30 of the data 22 for broadcast to the STBs 18. This is referred to as the publishing process. The application web server 14 preferably sends a trigger to the application generator 23 to activate the publishing process. The presentation component 20 may, for example, be typically broadcast in ASCII format, while the data 22 may be typically broadcast in a binary hierarchical (e.g., read-only) format (an example of which is described further hereinbelow). The presentation component 20, which may be typically HTML files, may be transmitted unchanged to the STBs 18.

The separation between the presentation component 20 and the data 22 may provide several advantages. For example, in such a manner, the system of the invention may improve response time (e.g., the data 22 may be optimized for read-only access). Bandwidth may be saved (e.g., the data 22 may be broadcast in optimized binary formats). As another example, the content 12 may be easily personalized (e.g., pages may be built on-demand, depending on the viewer's interaction and properties).

Each STB 18 preferably includes an STB browser 32 and a processor 34. The processor 34 preferably encapsulates data acquisition and memory management tasks, and is preferably in communication with the data carousel 26, an application programming interface (API) 36, and possibly a memory cache 38. At least part of the functionality of the processor 34 may be implemented in the STB browser 32. The STB browser 32 preferably accesses the data 22 via the processor 34.

In the STB 18, the data 22 is preferably bound to the presentation component 20 using a scripting language, such as but not limited to, ECMAScript. The scripting language preferably accesses the presentation component 20 using the API 36, such as but not limited to, a suitable version of the Document Object Model (DOM). The data 22 may also be accessed in the STB 18 by the API 36.

For communication via the back channel of the system, the headend 16 preferably includes an interactive channel module 40, which is preferably, without limitation, in communication with the application web server 14, application generator 23, iPackager 28, and processor 34.

The system of the invention may also include an extended TV (XTV) local file system 42, which may include extensions and integrations with other TV systems, such as but not limited to, XTV, SI and CA that enable provision of an extended range of options.

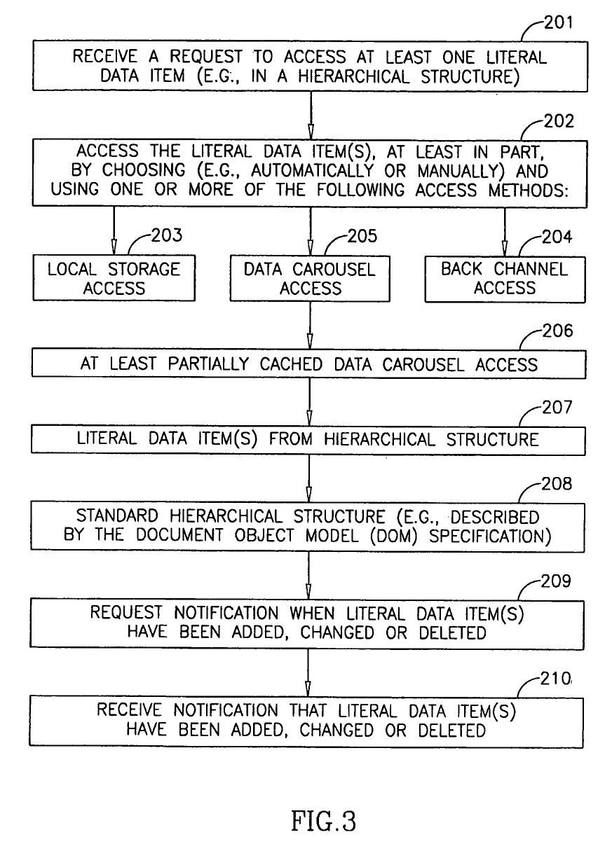

Reference is now made to FIG. 3, which illustrates a simplified flow chart of a method for literal data access, in accordance with a preferred embodiment of the present invention.

The STB 18 may receive a request to access one or more literal data items 100, e.g., in a hierarchical structure, as described above (step 201). The processor 34 and/or other components of STB 18 may handle and carry out such requests. The STB preferably accesses the literal data item(s) 100, at least in part (step 202), by choosing (e.g., automatically or manually) and using local storage access (step 203), back channel access (step 204) and/or data carousel access (step 205). The data carousel access may comprise at least partially cached data carousel access (step 206), such as by implementing memory cache 38. The literal data item(s) 100 may be from a hierarchical structure (step 207), such as but not limited to, a standard hierarchical structure, e.g., described by the DOM specification (step 208). The user may request notification when literal data item(s) 100 have been added, changed or deleted (step 209), and may receive notification that literal data item(s) 100 have been added, changed or deleted (step 210).

It has been mentioned hereinabove that the data 22 may be broadcast in a binary hierarchical (e.g., read-only) format. An example of this is now described.

As mentioned hereinabove, the DOM preferably defines the logical structure of documents and the methods by which documents are accessed and manipulated. Throughout the specification and claims, the term “document” is used in a broad sense, meaning any logically structured set or sets of data.

Using the DOM, a user may build documents, navigate the document structure, and add, modify, or delete elements and content (request and notification of which have been mentioned in steps 209 and 210 in FIG. 3). Any component of an HTML or XML document may be similarly treated using the DOM, for example. The implementation preferably preserves the order of the document.

An XML document may be divided into a number of separate modules. Each module preferably has a root element and includes all of the root's sub-tree, unless some descendant nodes are moved into separate modules.

Indexing structures are preferably, although not necessarily, global (not per module), and may be placed into separate module(s). Document fragments may be easily and quickly restored from their binary representation of the document.

XML binary structure is preferably read-only. If structural changes are made to the information set (addition/removal of nodes or order changes), the binary structure may have to be rebuilt for the entire document. In the case of a simple local data update (such as a change of attribute value or text content), it may only be necessary to rebuild the corresponding module for the local data.

Indexes and relations in the DOM which may be optimized include, without limitation, index by ID (which may be unique); index by element type (which may be multiple); child-parent relationship (which may be bi-directional); and descendant-ancestor relationship (which may be bi-directional).

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

It will be appreciated by person skilled in the art that the present invention is not limited by what has been particularly shown and described herein above. Rather the scope of the present invention is defined only by the claims that follow:

What is claimed is:

1. A method for accessing at least one literal data item in a hierarchical structure, the method comprising:
receiving a request to access at least one literal data item; and
accessing the at least one literal data item, at least in part, by choosing and using an access method chosen from the following group: local storage access, back channel access, and data carousel access.

2. The method according to claim 1, wherein said choosing comprises automatically choosing.

3. A method for accessing at least one literal data item in a hierarchical structure, the method comprising:
receiving a request to access at least one literal data item; and
accessing the at least one literal data item, at least in part, by using a data carousel access.

4. The method according to any of the above claims, wherein said data carousel access comprises at least partially cached data carousel access.

5. The method according to any of the above claims, wherein said hierarchical structure comprises a standard hierarchical structure.

6. The method according to claim 5, wherein said standard hierarchical structure comprises a standard hierarchical structure described by the Document Object Model (DOM) specification.

7. A method for accessing at least one literal data item in a hierarchical structure, the method comprising:
receiving a DOM format request to access at least one literal data item; and
fulfilling the DOM format request via data carousel access.

8. The method according to any of the above claims, further comprising requesting that notification be given when said at least one literal data item has been added, changed or deleted.

9. The method according to any of the above claims, further comprising receiving notification that said at least one literal data item has been added, changed or deleted.

10. The method according to any of the above claims, wherein said hierarchical structure is operable by an application programming interface (API).

11. The method according to claim 10, wherein said API comprises an event-based API.

12. The method according to claim 10, wherein said API comprises a tree-based API.

13. The method according to any of the above claims, further comprising providing content that comprises said at least one literal data item, said content comprising a presentation component and data.

14. The method according to claim 13, further comprising separating said presentation component from said data.

15. The method according to claim 14, wherein said presentation component is broadcast in ASCII format.

16. The method according to claim 14, wherein said data is broadcast in a binary format.

17. A system for accessing at least one literal data item in a hierarchical structure, comprising:
a set-top box (STB) adapted to receive a request to access at least one literal data item, and to access the at least one literal data item, at least in part, by choosing and using an access method chosen from the following group: local storage access, back channel access, and data carousel access.

18. The system according to claim 17, wherein said STB comprises a processor adapted to automatically choose which of said local storage access, back channel access, and data carousel access to access the at least one literal data item.

19. The system according to claim 17 or claim 18, further comprising a headend comprising an application generator adapted to broadcast to said STB via a data carousel.

20. The system according to claim 19 wherein said application generator is adapted to receive content from a content provider.

21. The system according to claim 20 wherein said content comprises presentation component and data.

22. The system according to claim 21 wherein said application generator is adapted to separate said presentation component from said data.

23. The system according to claim 21 or claim 22 wherein said presentation component comprises at least one of static HTML pages and dynamic HTML (DHTML) pages.

24. The system according to any of claims 21-23 wherein said data comprises XML data.

25. The system according to any of claims 17-24 wherein said STB comprises an extended TV (XTV) local file system.
